(19) United States
(12) Patent Application Publication
(10) Pub. No.: US 2022/0299487 A1
(43) Pub. Date: Sep. 22, 2022

(54) FLAME PROOF ANALYSIS DEVICE BASED ON CHROMATOGRAPHY

(71) Applicant: CCTEG Shenyang Research Institute, Fushun (CN)

(72) Inventors: Yuntao Liang, Fushun (CN); Junjie Zhang, Fushun (CN); Yong Sun, Fushun (CN); Jie Ren, Fushun (CN); Xuewei Ge, Fushun (CN); Depeng Zhang, Fushun (CN); Honghao He, Fushun (CN); Dong Zhang, Fushun (CN); Jilin Cui, Fushun (CN); Cheng'ao Fu, Fushun (CN); Wenjie Fang, Fushun (CN)

(21) Appl. No.: 17/558,308

(22) Filed: Dec. 21, 2021

(30) Foreign Application Priority Data
Mar. 22, 2021 (CN) 202110300872

(51) Int. Cl. G01N 30/60

(52) U.S. Cl. CPC G01N 30/6052; G01N 2030/025

(57) ABSTRACT

The disclosure includes a flame proof analysis device comprising a first chamber. In some embodiments, the flame proof analysis device comprises a power supply unit coupled to the first chamber. According to some embodiments, the flame proof analysis device comprises a chromatograph circuit board coupled to the first chamber. The flame proof analysis device may comprise a communication board coupled to the first chamber. In some embodiments, the flame proof analysis device comprises a control panel coupled to the first chamber. According to some embodiments, the flame proof analysis device comprises a suction pump coupled to the first chamber.

### CROSS-REFERENCE TO RELATED APPLICATIONS

This application claims the benefit of Chinese Patent Application No. 202110300872; filed Mar. 22, 2021; and entitled FLAME-PROOF ANALYSIS DEVICE BASED ON CHROMATOGRAPHIC PRINCIPLE; the entire contents of which are incorporated herein by reference.

### BACKGROUND

### Field

The invention relates to gas chromatography. In particular, the invention relates to a flame proof analysis device based on gas chromatography.

### Description of Related Art

Because of their high separation efficiency, quick analysis, high detection sensitivity, superior selection, and simultaneous analysis of multiple components, gas chromatographs have been extensively applied to fields such as the medical field, the petrochemical industry, environmental monitoring, and coal mine safety. Gas chromatographs are used continuously in the industrial environment and underground mines. Hazardous gases need to be injected into the gas chromatographs for them to operate, which may cause some problems that will be discussed in greater detail. Thus, there is a need for systems and methods that remedy the deficiencies that can be found in the prior art.

### SUMMARY

The disclosure includes a flame proof analysis device comprising a first chamber. In some embodiments, the flame proof analysis device comprises a power supply unit coupled to the first chamber. According to some embodiments, the flame proof analysis device comprises a chromatograph circuit board coupled to the first chamber. The flame proof analysis device may comprise a communication board coupled to the first chamber. In some embodiments, the flame proof analysis device comprises a control panel coupled to the first chamber. According to some embodiments, the flame proof analysis device comprises a suction pump coupled to the first chamber.

The power supply unit, the chromatograph circuit board, the communication board, the suction pump, and the control panel may be located within the first chamber. In some embodiments, the power supply unit comprises a transformer and an intrinsically safe power supply module electrically coupled to the transformer. According to some embodiments, the power supply unit further comprises a switching power supply electrically coupled to the transformer and the intrinsically safe power supply module.

The flame proof analysis device may comprise an external power supply. In some embodiments, the power supply unit is electrically coupled to the external power supply. According to some embodiments, the power supply unit has an alternating current input voltage of 127 to 1140 volts. The power supply unit may have an alternating current output voltage of 5 to 36 volts. In some embodiments, the chromatograph circuit board has a direct current power supply voltage of 5 to 24 volts.

According to some embodiments, the flame proof analysis device further comprises a second chamber. The flame proof analysis device may furth comprise a gas detector coupled to the second chamber. In some embodiments, the flame proof analysis device further comprises a chromatographic column coupled to the second chamber. According to some embodiments, the flame proof analysis device further comprises a chromatographic column heater band coupled to the second chamber. The flame proof analysis device may further comprise a chromatographic column temperature sensor coupled to the second chamber. In some embodiments, the flame proof analysis device further comprises a sample injection device coupled to the second chamber. According to some embodiments, the flame proof analysis device further comprises a solenoid valve group coupled to the second chamber. The flame proof analysis device may further comprise a carrier gas injection port coupled to the second chamber. In some embodiments, the flame proof analysis device further comprises a standard gas injection port coupled to the second chamber. According to some embodiments, the flame proof analysis device further comprises a sample gas injection port coupled to the second chamber.

The gas detector, the chromatographic column heater band, the chromatographic column temperature sensor, the sample injection device, the solenoid valve group, the carrier gas injection port, the standard gas injection port, and the sample gas injection port may be located within the second chamber.

In some embodiments, the flame proof analysis device further comprises a terminal block. According to some embodiments, the flame proof analysis device further comprises a signal isolation module coupled to the chromatograph circuit board. A control line of the sample injection device, a transmission line of the gas detector, and the chromatographic column temperature sensor may be coupled to the signal isolation module through the terminal block. In some embodiments, the signal isolation module is coupled to the chromatograph circuit board.

According to some embodiments, a power cord of the gas detector, the chromatographic column heater band, and the sample injection device are coupled to the chromatograph circuit board through the terminal block. The gas detector, the chromatographic column heater band, and the sample injection device may be powered by the chromatograph circuit board independent of one another. In some embodiments, the flame proof analysis device further comprises a computer. According to some embodiments, the communication board is separately coupled to the chromatograph circuit board, the control panel, and the computer.

The disclosure also includes a method of using a flame proof analysis device wherein the flame proof analysis device comprises a sample injection device, a chromatographic column, a gas detector, and a carrier gas injection port. In some embodiments, the method of using a flame proof analysis device comprises turning on a carrier gas flow. According to some embodiments, the method of using a flame proof analysis device comprises passing a carrier gas, via the carrier gas injection port, through the sample injection device, the chromatographic column, and the gas detector.

The flame proof analysis device may further comprise a power switch, an input power, and a power supply unit. In some embodiments, the method of using a flame proof analysis device further comprises turning on the power switch. According to some embodiments, the method of using a flame proof analysis device further comprises sending a current from the input power to the power supply unit.

The flame proof analysis device may further comprise a computer, a communication board, a chromatographic circuit board, a chromatographic column heater band, and a chromatographic column temperature sensor. In some embodiments, the method of using a flame proof analysis device further comprises setting a temperature, via the computer, of the chromatographic column. According to some embodiments, the method of using a flame proof analysis device further comprises sending at least one parameter, via the communication board, to the chromatograph circuit board. The method of using a flame proof analysis device may further comprise controlling the chromatographic column heater band, via the chromatograph circuit board, according to a difference between the value of the chromatographic column temperature sensor and a set value. In some embodiments, the method of using a flame proof analysis device further comprises heating, via the chromatographic column heater band, the chromatographic column.

The flame proof analysis device may further comprise a solenoid valve group, a control panel, and a suction pump. In some embodiments, the method of using a flame proof analysis device further comprises opening, via the control panel, a solenoid valve in the solenoid valve group. According to some embodiments, the method of using a flame proof analysis device further comprises activating, via the chromatograph circuit board, the suction pump. The method of using a flame proof analysis device may further comprise injecting a sample gas, via the suction pump, into the sample injection device. In some embodiments, the method of using a flame proof analysis device further comprises driving the sample gas, via the carrier gas, through the chromatographic column and the gas detector. According to some embodiments, the method of using a flame proof analysis device further comprises separating the carrier gas and the sample gas. The method of using a flame proof analysis device may further comprise detecting the sample gas.

### BRIEF DESCRIPTION OF THE DRAWINGS

These and other features, aspects, and advantages are described below with reference to the drawings, which are intended to illustrate, but not to limit, the invention. In the drawings, like reference characters denote corresponding features consistently throughout similar embodiments.

FIG. 1 illustrates a diagrammatic view of the flame proof analysis device, according to some embodiments.

FIG. 2 illustrates a diagrammatic view of the power supply unit, according to some embodiments.

FIG. 3 illustrates a diagrammatic view of the power supply unit, according to some embodiments.

FIG. 4 illustrates a flowchart depicting a method of using a flame proof analysis device, according to some embodiments.

FIG. 5 illustrates a flowchart depicting a method of using a flame proof analysis device, according to some embodiments.

FIG. 6 illustrates a flowchart depicting a method of using a flame proof analysis device, according to some embodiments.

### DETAILED DESCRIPTION

Although specific embodiments and examples are disclosed below, inventive subject matter extends beyond the specifically disclosed embodiments to other alternative embodiments and/or uses, and to modifications and equivalents thereof. Thus, the scope of the claims appended hereto is not limited by any of the particular embodiments described below. For example, in any method or process disclosed herein, the acts or operations of the method or process may be performed in any suitable sequence and are not necessarily limited to any particular disclosed sequence. Various operations may be described as multiple discrete operations in turn, in a manner that may be helpful in understanding certain embodiments; however, the order of description should not be construed to imply that these operations are order-dependent. Additionally, the structures, systems, and/or devices described herein may be embodied as integrated components or as separate components.

For purposes of comparing various embodiments, certain aspects and advantages of these embodiments are described. Not necessarily all such aspects or advantages are achieved by any particular embodiment. Thus, for example, various embodiments may be carried out in a manner that achieves or optimizes one advantage or group of advantages as taught herein without necessarily achieving other aspects or advantages as may also be taught or suggested herein.

### COMPONENT INDEX

1—First chamber
2—Second chamber
100—Input power
101—Power supply unit
102—Chromatograph circuit board
103—Computer
104—Communication board
105—Control panel
106—Terminal block
107—Suction pump
200—Carrier gas injection port
201—Standard gas injection port
202—Sample gas injection port
203—Solenoid valve group
204—Gas detector
205—Chromatographic column heater band
206—Chromatographic column
207—Chromatographic column temperature sensor
208—Sample injection device
1011—Transformer
1012—Switching power supply
1013—Intrinsically safe power supply module

Gas chromatographs are used continuously in the industrial environment and underground mines, where hazardous gases need to be injected into the chromatographs for analysis. This may lead to an issue where the hazardous gases being analyzed leak, causing the circuit to spark, and potentially causing the device to explode.

The present disclosure provides for a new type of flame proof analysis device based on gas chromatography. This disclosure separates the electrical components and the gas components into separate chambers. This separation of the electrical circuit system and the gas circuit system may minimize or completely mitigate the risk of the device exploding due to a gas leak. Thus, this disclosure improves the safety of gas analysis devices.

As China attaches an increasing importance to safety, more attention is being attracted to the use of devices in places where they are at risk of explosion. In the field of coal mine safety, China has raised the safety standard for gas analysis devices. As stated in the AB[2016] No. 35 document issued by AnBiao National Center for mining products Safety Sign, underground gas analysis devices, if continuously injected with samples containing hazardous gas, are extremely vulnerable to explosion provided that the gas leaks and contacts the circuit, causing the circuit to spark.

With a goal of improving the safety of the analysis device based on gas chromatography used in hazardous locations, the electrical components and the gas components are installed in separate chambers according to this disclosure. This causes a separation of the electrical circuit system and the gas circuit system within the analysis device. Thus, the problem of mixed electrical circuits and gas circuits is solved, as there are no gas components in the electrical circuit chamber, and there are no electrical components in the gas circuit chamber. Even if the gas leaks, it will not be able to make contact with the electrical circuit, thus there is a minimized or mitigated issue of the circuit sparking. This means that the risk of the analysis device exploding is also minimized or mitigated, thus improving the safety of using the analysis device based on gas chromatography in hazardous places.

### Mode of Fabricating the Flame Proof Analysis Device

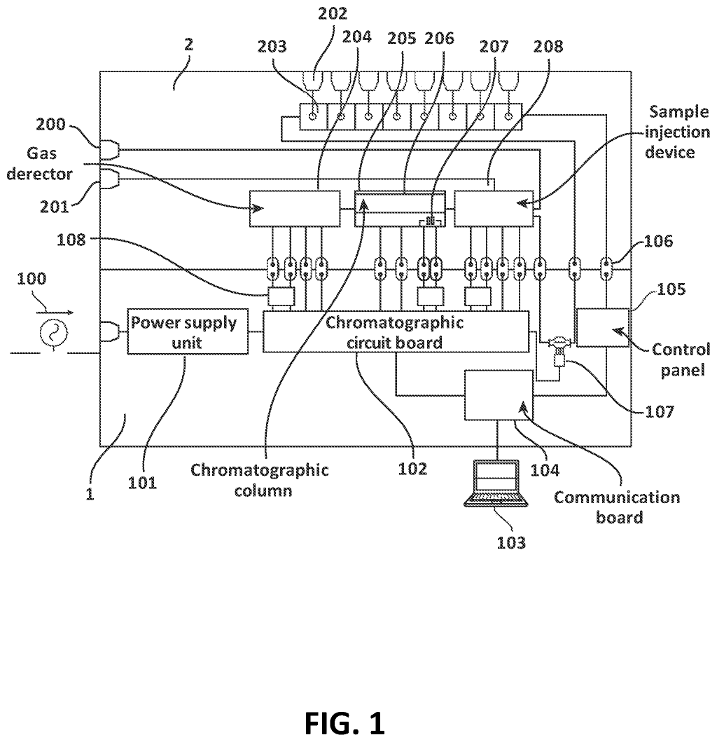

FIG. 1 illustrates a diagrammatic view of the flame proof analysis device, according to tom some embodiments. The flame proof analysis device may include a first chamber 1, a power supply unit 101, a chromatograph circuit board 102, a communication board 104, a control panel 105, and a suction pump 107. According to some embodiments, the power supply unit 101, the chromatograph circuit board 102, the communication board 104, the control panel 105, and the suction pump 107 are installed in the first chamber 1. In some embodiments, the chromatograph circuit board 102 has a direct current power supply voltage of 5 to 24 volts.

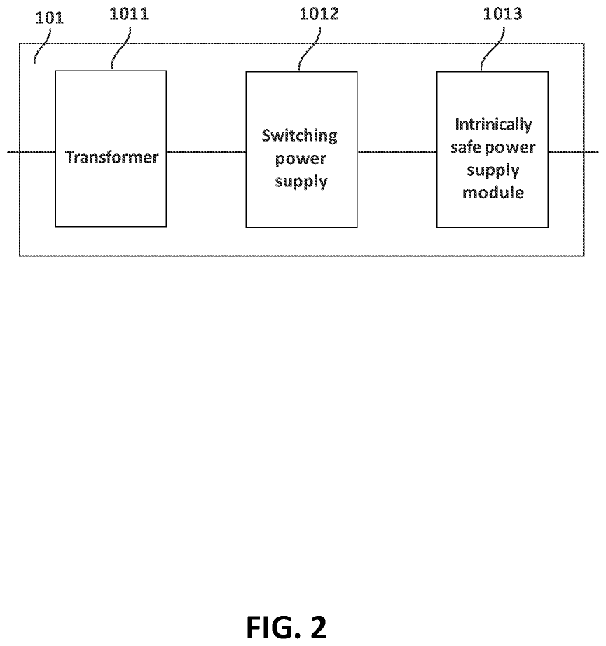

As shown in FIG. 2, the flame proof analysis device may also include a second chamber 2, a gas detector 204, a chromatographic column 206, a chromatographic column heater band 205, a chromatographic column temperature sensor 207, a sample injection device 208, a solenoid valve group 203, a carrier gas injection port 200, a standard gas injection port 201, and a sample gas injection port 202. In some embodiments, the gas detector 204, the chromatographic column 206, the chromatographic column heater band 205, the chromatographic column temperature sensor 207, the sample injection device 208, the solenoid valve group 203, the carrier gas injection port 200, the standard gas injection port 201, and the sample gas injection port 202 are installed in the second chamber 2.

According to some embodiments, the flame proof analysis device also includes a terminal block 106 and a signal isolation module coupled to the chromatograph circuit board 102. A control line of the sample injection device 208, a transmission line of the gas detector 204, and the chromatographic column temperature sensor 207 may be coupled to the signal isolation module through the terminal block 106. In some embodiments, the signal isolation module is coupled to the chromatograph circuit board 102. According to some embodiments, a power cord of the gas detector 204, the chromatographic column heater band 205, and the sample injection device 208 are coupled to the chromatograph circuit board 102 through the terminal block 106. According to some embodiments, the gas detector 204, the chromatographic column heater band 205, and the sample injection device 208 are powered by the chromatograph circuit board 102 independently from one another.

The flame proof analysis device may include a computer 103. According to some embodiments, the communication board 104 is separately coupled to the chromatograph circuit board 102, the control panel 105, and the computer 103.

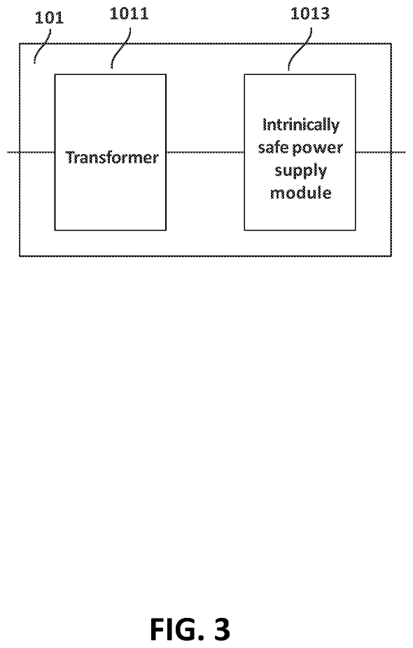

FIGS. 2 and 3 illustrate diagrammatic views of the power supply unit 101, according to some embodiments. As shown by FIG. 2, the power supply unit 101 may comprise a transformer 1011, a switching power supply 1012, and an intrinsically safe power supply module 1013. As illustrated by FIG. 3, in some embodiments, the switching power supply 1012 is not needed, so the power supply unit 101 only comprises a transformer 1011 and an intrinsically safe power supply module 1013.

According to some embodiments, the power supply unit 101 is electrically coupled to an external power supply. In some embodiments, the power supply unit 101 has an alternating current input voltage of 127 to 1140 volts. The power supply unit 101 may have an alternating current output voltage of 5 to 36 volts.

### Procedure of Using the Flame Proof Analysis Device

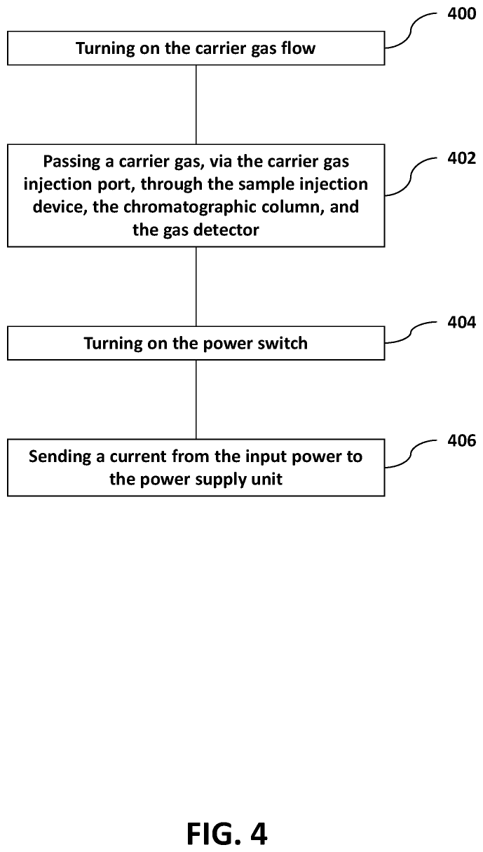

FIG. 4 illustrates a method of using a flame proof analysis device, wherein the flame proof analysis device comprises a sample injection device, a chromatographic column, a gas detector, a carrier gas injection port, a power switch, an input power, and a power supply unit. In some embodiments, the method includes turning on the carrier gas flow (at step 400). According to some embodiments, the method includes passing a carrier gas, vias the carrier gas injection port, through the sample injection device, the chromatographic column, and the gas detector (at step 402). The method may include turning on the power switch (at step 404). In some embodiments, the method includes sending a current from the input power to the power supply unit (at step 406).

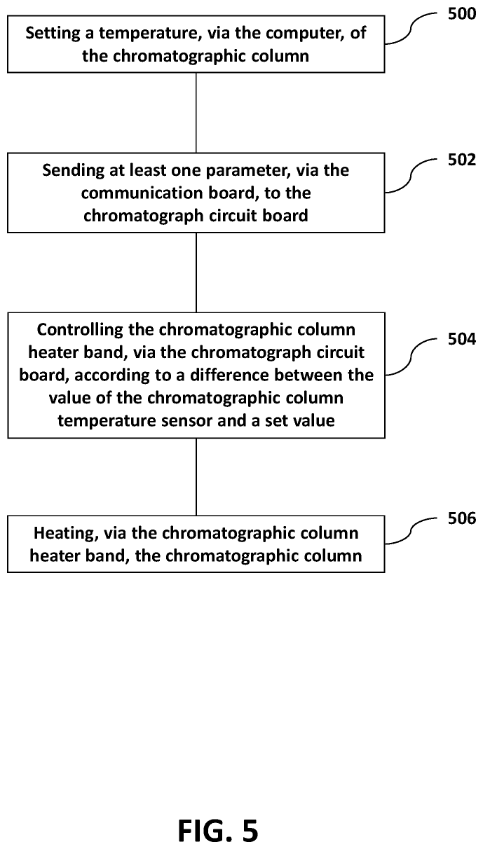

FIG. 5 illustrates a method of using a flame proof analysis device, wherein the flame proof analysis device further comprises a computer, a communication board, a chromatographic circuit board, a chromatographic column heater band, and a chromatographic column temperature sensor. According to some embodiments, the method includes setting a temperature, via the computer, of the chromatographic column (at step 500). The method may include sending at least one parameter, via the communication board, to the chromatograph circuit board (at step 502). In some embodiments, the method includes controlling the chromatographic column heater band, via the chromatograph circuit board, according to a difference between the value of the chromatographic column temperature sensor and a set value (at step 504). According to some embodiments, the method includes heating, via the chromatographic column heater band, the chromatographic column (at step 506).

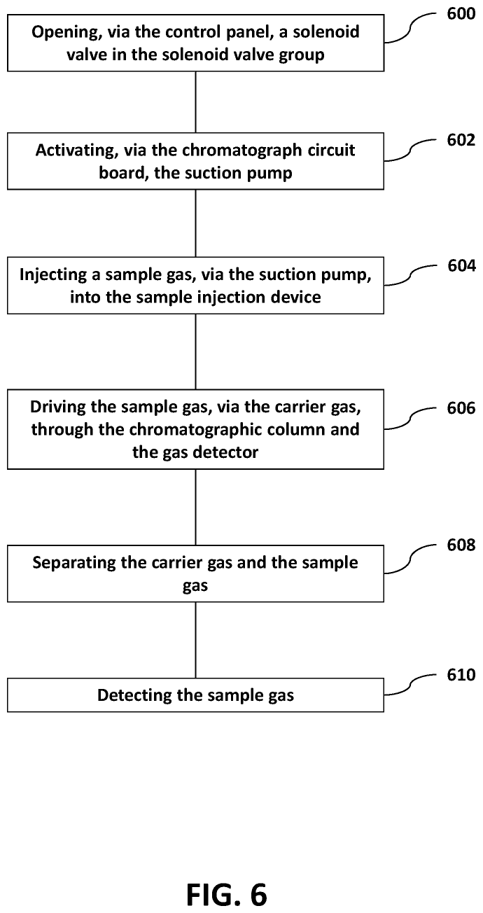

FIG. 6 illustrates a method of using a flame proof analysis device, wherein the flame proof analysis device further comprises a solenoid valve group, a control panel, and a suction pump. The method may include opening, via the control panel, a solenoid valve in the solenoid valve group (at step 600). In some embodiments, the method includes activating, via the chromatograph circuit board, the suction pump (at step 602). According to some embodiments, the method includes injecting a sample gas, via the suction pump, into the sample injection device (at step 604). The method may include driving the sample gas, via the carrier gas, through the chromatographic column and the gas detector (at step 606). In some embodiments, the method includes separating the carrier gas and the sample gas (at step 608). According to some embodiments, the method includes detecting the sample gas (at step 610).

### Interpretation

None of the steps described herein is essential or indispensable. Any of the steps can be adjusted or modified. Other or additional steps can be used. Any portion of any of the steps, processes, structures, and/or devices disclosed or illustrated in one embodiment, flowchart, or example in this specification can be combined or used with or instead of any other portion of any of the steps, processes, structures, and/or devices disclosed or illustrated in a different embodiment, flowchart, or example. The embodiments and examples provided herein are not intended to be discrete and separate from each other.

The section headings and subheadings provided herein are nonlimiting. The section headings and subheadings do not represent or limit the full scope of the embodiments described in the sections to which the headings and subheadings pertain. For example, a section titled “Topic 1” may include embodiments that do not pertain to Topic 1, and embodiments described in other sections may apply to and be combined with embodiments described within the “Topic 1” section.

To increase the clarity of various features, other features are not labeled in each figure.

The various features and processes described above may be used independently of one another or may be combined in various ways. All possible combinations and subcombinations are intended to fall within the scope of this disclosure. In addition, certain method, event, state, or process blocks may be omitted in some implementations. The methods, steps, and processes described herein are also not limited to any particular sequence, and the blocks, steps, or states relating thereto can be performed in other sequences that are appropriate. For example, described tasks or events may be performed in an order other than the order specifically disclosed. Multiple steps may be combined in a single block or state. The example tasks or events may be performed in serial, parallel, or some other manner. Tasks or events may be added to or removed from the disclosed example embodiments. The example systems and components described herein may be configured differently than described. For example, elements may be added to, removed from, or rearranged compared to the disclosed example embodiments.

Conditional language used herein, such as, among others, “can,” “could,” “might,” “may,” “e.g.,” and the like, unless expressly stated otherwise, or otherwise understood within the context as used, is generally intended to convey that certain embodiments include, while other embodiments do not include, certain features, elements and/or steps. Thus, such conditional language is not generally intended to imply that features, elements, and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. Conjunctive language such as the phrase “at least one of X, Y, and Z,” unless expressly stated otherwise, is otherwise understood with the context as used in general to convey that an item, term, etc. may be either X, Y, or Z. Thus, such conjunctive language is not generally intended to imply that certain embodiments require at least one of X, at least one of Y, and at least one of Z to each be present.

The term “and/or” means that “and” applies to some embodiments and “or” applies to some embodiments. Thus, A, B, and/or C can be replaced with A, B, and C written in one sentence and A, B, or C written in another sentence. A, B, and/or C means that some embodiments can include A and B, some embodiments can include A and C, some embodiments can include B and C, some embodiments can only include A, some embodiments can include only B, some embodiments can include only C, and some embodiments can include A, B, and C. The term “and/or” is used to avoid unnecessary redundancy.

While certain example embodiments have been described, these embodiments have been presented by way of example only and are not intended to limit the scope of the inventions disclosed herein. Thus, nothing in the foregoing description implies that any particular feature, characteristic, step, module, or block is necessary or indispensable. Indeed, the novel methods and systems described herein may be embodied in a variety of other forms; furthermore, various omissions, substitutions, and changes in the form of the methods and systems described herein may be made without departing from the spirit of the inventions disclosed herein.

What is claimed is:

1. A flame proof analysis device comprising:
a first chamber;
a power supply unit coupled to the first chamber;
a chromatograph circuit board coupled to the first chamber;
a communication board coupled to the first chamber;
a control panel coupled to the first chamber; and
a suction pump coupled to the first chamber.

2. The flame proof analysis device of claim 1, wherein the power supply unit, the chromatograph circuit board, the communication board, the suction pump, and the control panel are located within the first chamber.

3. The flame proof analysis device of claim 1, the power supply unit comprising:
a transformer; and
an intrinsically safe power supply module electrically coupled to the transformer.

4. The flame proof analysis device of claim 3, the power supply unit further comprising a switching power supply electrically coupled to the transformer and the intrinsically safe power supply module.

5. The flame proof analysis device of claim 1, further comprising an external power supply,
wherein the power supply unit is electrically coupled to the external power supply,
wherein the power supply unit has an alternating current input voltage of 127 to 1140 volts, and
wherein the power supply unit has an alternating current output voltage of 5 to 36 volts.

6. The flame proof analysis device of claim 1, wherein the chromatograph circuit board has a direct current power supply voltage of 5 to 24 volts.

7. The flame proof analysis device of claim 1, further comprising:
a second chamber;
a gas detector coupled to the second chamber;
a chromatographic column coupled to the second chamber;
a chromatographic column heater band coupled to the second chamber;
a chromatographic column temperature sensor coupled to the second chamber;
a sample injection device coupled to the second chamber;
a solenoid valve group coupled to the second chamber;
a carrier gas injection port coupled to the second chamber;
a standard gas injection port coupled to the second chamber; and
a sample gas injection port coupled to the second chamber.

8. The flame proof analysis device of claim 7, wherein the gas detector, the chromatographic column heater band, the chromatographic column temperature sensor, the sample injection device, the solenoid valve group, the carrier gas injection port, the standard gas injection port, and the sample gas injection port are located within the second chamber.

9. The flame proof analysis device of claim 7, further comprising:
a terminal block; and
a signal isolation module coupled to the chromatograph circuit board.

10. The flame proof analysis device of claim 9, wherein a control line of the sample injection device, a transmission line of the gas detector, and the chromatographic column temperature sensor are coupled to the signal isolation module through the terminal block, and
wherein the signal isolation module is coupled to the chromatograph circuit board.

11. The flame proof analysis device of claim 9, wherein a power cord of the gas detector, the chromatographic column heater band, and the sample injection device are coupled to the chromatograph circuit board through the terminal block.

12. The flame proof analysis device of claim 9, wherein the gas detector, the chromatographic column heater band, and the sample injection device are powered by the chromatograph circuit board independent of one another.

13. The flame proof analysis device of claim 10, further comprising a computer,
wherein the communication board is separately coupled to the chromatograph circuit board, the control panel, and the computer.

14. A method of using a flame proof analysis device, wherein the flame proof analysis device comprises a sample injection device, a chromatographic column, a gas detector, and a carrier gas injection port, the method comprising:
turning on a carrier gas flow; and
passing a carrier gas, via the carrier gas injection port, through the sample injection device, the chromatographic column, and the gas detector.

15. The method of using a flame proof analysis device of claim 14, wherein the flame proof analysis device further comprises a power switch, an input power, and a power supply unit, the method further comprising:
turning on the power switch; and
sending a current from the input power to the power supply unit.

16. The method of using a flame proof analysis device of claim 15, wherein the flame proof analysis device further comprises a computer, a communication board, a chromatographic circuit board, a chromatographic column heater band, and a chromatographic column temperature sensor, the method further comprising:
setting a temperature, via the computer, of the chromatographic column;
sending at least one parameter, via the communication board, to the chromatograph circuit board;
controlling the chromatographic column heater band, via the chromatograph circuit board, according to a difference between the value of the chromatographic column temperature sensor and a set value; and
heating, via the chromatographic column heater band, the chromatographic column.

17. The method of using a flame proof analysis device of claim 16, wherein the flame proof analysis device further comprises a solenoid valve group, a control panel, and a suction pump, the method further comprising:
opening, via the control panel, a solenoid valve in the solenoid valve group;
activating, via the chromatograph circuit board, the suction pump;
injecting a sample gas, via the suction pump, into the sample injection device;
driving the sample gas, via the carrier gas, through the chromatographic column and the gas detector;
separating the carrier gas and the sample gas; and
detecting the sample gas.
